(19) United States
(12) Patent Application Publication
(10) Pub. No.: US 2023/0385823 A1
(43) Pub. Date: Nov. 30, 2023

(54) SYSTEM AND METHOD FOR CRYPTOGRAPHIC ASSET TRANSACTION

(71) Applicant: David Franklin Hanson, JR., Richardson, TX (US)

(72) Inventor: David Franklin Hanson, JR., Richardson, TX (US)

(21) Appl. No.: 17/828,047

(22) Filed: May 31, 2022

(51) Int. Cl. G06Q 20/40; H04L 9/00; G06Q 20/38; G06Q 20/36

(52) U.S. Cl. CPC G06Q 20/401; H04L 9/50; G06Q 20/3825; G06Q 20/3672; G06Q 2220/00

(57) ABSTRACT

A system for cryptographic asset transaction is disclosed. The system may be configured to provide a first user interface (UI) element for performing a first cryptographic asset transaction of first cryptographic asset. The system receives a first input corresponding to the UI element, for initiation of the first cryptographic asset transaction. The first input corresponds to a single action performed by user. The system retrieves a first set of information associated with registration details of the user, based on the first input. The system transmits a second set of information associated with details of the first cryptographic asset to a blockchain network associated with the first cryptographic asset. The system generates an order for the transaction of the first cryptographic asset, based on the first set of information and the second set of information, to complete the transaction of the first cryptographic asset.

### TECHNICAL FIELD

This disclosure relates generally to transaction of cryptographic assets, and more particularly to system and method of transaction of non-fungible token (NFT) on a digital platform.

### BACKGROUND

With the advancement of blockchain technologies, cryptographic assets are becoming hugely popular. The cryptographic assets may include fungible assets, such as cryptocurrency and non-fungible assets (NFTs). The NFTs are units of data that are uniquely identifiable and may not be replicated. The NFTs are associated with several data formats, for example, images (such as digital art), videos and audio. The NFTs may be purchased, minted, or sold by a user.

Conventionally, different digital platforms (such as marketplaces) are available for one or more transactions such as minting, purchasing and selling of the NFTs. However, the transactions of the NFTs may be a tedious process for the user. For example, the minting of the NFTs may require multiple steps to be performed by the user. The performance of such multiple steps may be technically challenging for the user. Further, the purchasing of the NFTs may be time-consuming and technically difficult for the user to understand. Moreover, a registration process on such digital platforms requires linking of individual cryptographic wallets associated with the user with the digital platforms for the transactions of the NFTs which may further be a complicated task for the user.

### SUMMARY

In one embodiment, a system for cryptographic asset transaction is disclosed. The system may include a processor and a memory communicatively coupled to the processor. The memory stores a plurality of processor-executable instructions which upon execution by the processor cause the processor to provide a first user interface (UI) element to a user for performing at least a first cryptographic asset transaction of a first cryptographic asset. The plurality of processor-executable instructions, upon execution by the processor, may further cause the processor to receive a first input corresponding to the first UI element, for initiation of at least the first cryptographic asset transaction. The first input corresponds to a single action performed by the user. The plurality of processor-executable instructions, upon execution by the processor, may further cause the processor to retrieve a first set of information associated with the user, based on the received first input. The first set of information is associated with at least registration details of the user. The plurality of processor-executable instructions, upon execution by the processor, may further cause the processor to transmit a second set of information to a blockchain network associated with the first cryptographic asset. The second set of information is associated with at least details of the first cryptographic asset. The plurality of processor-executable instructions, upon execution by the processor, may further cause the processor to generate an order for the transaction of the first cryptographic asset, based on the retrieved first set of information and the transmitted second set of information, to complete the transaction of the first cryptographic asset.

In another embodiment, a method of cryptographic asset transaction is provided. The method may include providing a first user interface (UI) element to a user for performing at least a first cryptographic asset transaction of a first cryptographic asset. The method may further include receiving a first input corresponding to the first UI element, for initiation of at least the first cryptographic asset transaction. The first input corresponds to a single action performed by the user. The method may further include retrieving a first set of information associated with the user, based on the received first input. The first set of information is associated with at least registration details of the user. The method may further include transmitting a second set of information to a blockchain network associated with the first cryptographic asset. The second set of information is associated with at least details of the first cryptographic asset. The method may further include generating an order for the transaction of the first cryptographic asset, based on the retrieved first set of information and the transmitted second set of information, to complete the transaction of the first cryptographic asset.

In yet another embodiment, a non-transitory computer-readable medium storing computer-executable instructions for performing interaction is disclosed. The computer-executable instructions may be configured for providing a first user interface (UI) element to a user for performing at least a first cryptographic asset transaction of a first cryptographic asset. The computer-executable instructions may be further configured for receiving a first input corresponding to the first UI element, for initiation of at least the first cryptographic asset transaction. The first input corresponds to a single action performed by the user. The computer-executable instructions may be further configured for retrieving a first set of information associated with the user, based on the received first input. The first set of information is associated with at least registration details of the user. The computer-executable instructions may be further configured for transmitting a second set of information to a blockchain network associated with the first cryptographic asset. The second set of information is associated with at least details of the first cryptographic asset. The computer-executable instructions may be further configured for generating an order for the transaction of the first cryptographic asset, based on the retrieved first set of information and the transmitted second set of information, to complete the transaction of the first cryptographic asset.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a network environment of a system for cryptographic asset transaction, in accordance with an embodiment.

FIG. 2 is a functional block diagram of the system of FIG. 1 for implementing various embodiments, in accordance with an embodiment.

FIG. 3 is a block diagram for a registration process of a user, in accordance with an embodiment.

FIG. 4 is a block diagram for purchase of a first cryptographic asset based on a single action performed by a user, in accordance with an embodiment.

FIG. 5 is a block diagram for minting of a second cryptographic asset, based on a preference of a user, in accordance with an embodiment.

FIG. 6 is a flowchart illustrating a method for cryptographic asset transaction, in accordance with an embodiment.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

One or more techniques are disclosed that seek to provide a solution to the above-mentioned challenges faced by the technologies of the prior art, by providing a platform for simplified transactions of a plurality of cryptographic assets. A user interface (UI) associated with the platform may be provided to a user. By use of the UI, simplified transactions of the plurality of cryptographic assets, such as purchasing and minting of the plurality of cryptographic assets may be provided to the user. The techniques provide a first UI element on the UI that may be utilized for at least a first cryptographic asset transaction, such as the purchase of a first cryptographic asset of the plurality of cryptographic assets. A first input may be received from the user via the first UI element. For example, the input may be a single action, such as a single click provided by the user. Based on the single action provided by the user, the purchase of the first cryptographic asset be completed for the user. Thus, the system may simplify the process of transaction, such as purchase of the plurality of cryptographic assets by eliminating various steps required for the purchase and providing the user with the first UI element that may enable purchase of the one or more first cryptographic assets of the plurality of cryptographic assets.

Furthermore, the techniques provide a second UI element on the UI for performing at least a second cryptographic asset transaction, such as minting of a second cryptographic asset based on a preference of the user. Conventionally, the minting of the cryptographic assets may require multiple technically challenging steps that may require for example, coding skills. The provided techniques may automate the steps for minting of the second cryptographic asset by use of one or more UI scripting languages. The system may utilize the one or more UI scripting languages to mint the second cryptographic asset for the user according to the preference of the user. Moreover, the techniques provide a simplified registration process for the user. The system generates a user account on the platform and links a cryptographic wallet associated with the user with the user account. The system may enable registration of one or more cryptographic elements (such as cryptocurrencies) with the cryptographic wallet linked to the user account. Thus, the techniques provide a single platform for performance of various transactions, such as purchasing, minting and selling of the plurality of cryptographic assets in a simplified and technically uncomplicated manner.

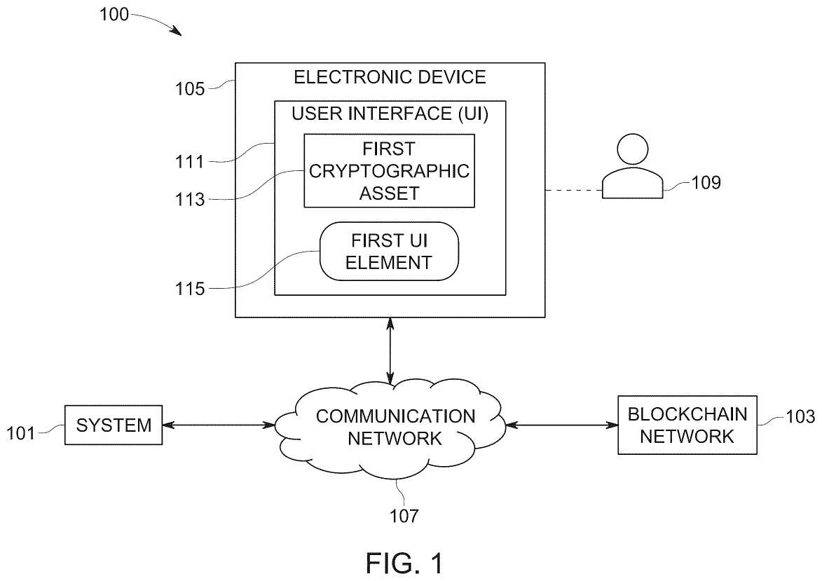

In one embodiment, a network environment 100 of a system for cryptographic asset transaction is illustrated in FIG. 1, in accordance with an embodiment. The network environment 100 may include a system 101, a blockchain network 103, an electronic device 105 and a communication network 107. The electronic device 105 may be associated with a user 109. The electronic device 105 may further include a user interface (UI) 111. The UI 111 may display a first cryptographic asset 113 and a first UI element 115.

The system 101 may be a computing device having data processing capability. In particular, the system 101 may have capability for performing a set of transactions, such as a first cryptographic asset transaction and a second cryptographic asset transaction. For example, the first cryptographic asset transaction may include a purchase of the first cryptographic asset 113. The second cryptographic asset transaction may be associated with a minting of a second cryptographic asset. The set of transactions may further include selling of a cryptographic asset. Examples of the system 101 may include, but are not limited to a desktop, a laptop, a notebook, a netbook, a tablet, a smartphone, a mobile phone, an application server, a web server, or the like.

The blockchain network 103 may be a distributed database that may include a plurality of nodes. Each node of the plurality of nodes may be associated with an entity such as an individual user or an enterprise. The blockchain network 103 may be utilized to securely store a plurality of cryptographic assets that may include the first cryptographic asset 113. The system 101 may be configured to transmit a second set of information to the blockchain network 103 associated with the first cryptographic asset 113. The second set of information may include for example, details of the first cryptographic asset 113, authentication data associated with the user and payment information required for completion of the transaction. Examples of the blockchain network 103 may include, but are not limited to, Ethereum blockchain, Flow blockchain, Binance smart chain blockchain, Cardano blockchain, Tezos blockchain, Tron blockchain, algorand blockchain, Hyperledger blockchain and ripple blockchain.

The electronic device 105 may be a computing device (such as a client device) associated with the user 109 capable of rendering the UI 111. The electronic device 105 may be further capable of receiving a first input via the UI 111 from the user 109. The first input may correspond to a single action performed by the user 109. Examples of the electronic device 105 may include, but are not related to, a desktop, the laptop, the notebook, the netbook, the tablet, the smartphone, the mobile phone, the application server, the web server, an internet-of-things (IoT) device, an augmented reality (AR) device, a virtual reality (VR) device, a mixed reality device, a gaming device, an infotainment device, or the like.

The UI 111 may correspond to a platform associated with the plurality of cryptographic assets. The platform may be, for example, a digital marketplace or an electronic commerce platform for the performance of the set of transactions of the plurality of cryptographic assets. For example, the platform may be utilized for purchase of the first cryptographic asset 113. In some embodiments, the system 101 may be a part of the platform associated with the plurality of cryptographic assets.

The first cryptographic asset 113 may be displayed on the UI 111. The first cryptographic asset 113 may be for example, non-fungible tokens (NFTs) or the fungible tokens, such as cryptographic currencies. The first cryptographic asset 113 may be a first NFT displayed on the UI 111 for the cryptographic asset transaction such as purchase. The first UI element 115 may be utilized for providing an input corresponding to the transaction of the first cryptographic asset 113. For example, the first UI element 115 may be utilized to receive the first input for purchase of the first cryptographic asset 113. The first input may be the single action, such as a touch input provided by the user 109.

The system 101, the blockchain network 103 and the electronic device 105 may be communicatively coupled with each other via the communication network 107. The communication network 107 may be a wired or a wireless network and the examples may include, but are not limited to the Internet, Wireless Local Area Network (WLAN), Wi-Fi, Long Term Evolution (LTE), Worldwide Interoperability for Microwave Access (WiMAX), and General Packet Radio Service (GPRS).

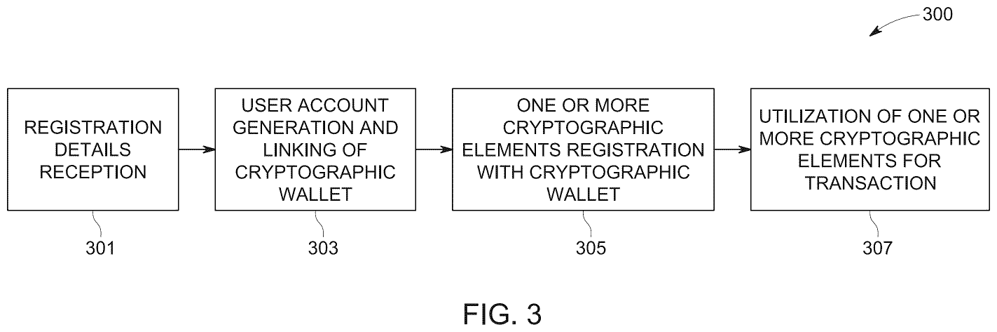

In operation, the system 101 may be utilized by the user 109 for the cryptographic asset transactions. In accordance with an embodiment, the system 101 may receive registration details associated with the user 109 via the UI 111 associated with the platform for the cryptographic asset transactions. The registration details may include at least data associated with a cryptographic wallet associated with the user 109. Based on the received registration details, the system 101 maty generate a user account associated with the user 109 on the UI 111. The cryptographic wallet associated with the user 109 may be linked with the generated user account. The system 101 may further enable registration of one or more cryptographic elements with the linked cryptographic wallet. The one or more cryptographic elements may be utilized for the transaction of the first cryptographic asset 113. Details of the generation of the user account are further provided, for example, in FIG. 3.

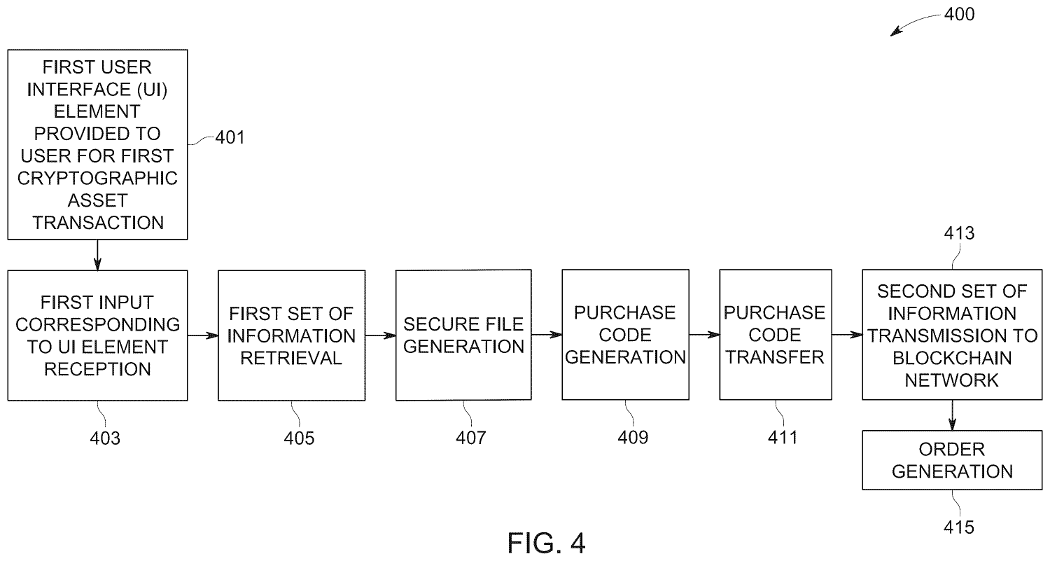

The system 101 may be configured to provide the first UI element 115 on the UI 111 to the user 109 for performing at least a first cryptographic asset transaction. In some embodiments, the first cryptographic asset transaction may correspond to purchase of the first cryptographic asset 113. The system 101 may be further configured to receive the first input corresponding to the first UI element 115. The first input may correspond to the single action performed by the user. The system 101 may be further configured to retrieve a first set of information associated with the user 109, based on the received first input. The first set of information may be associated with at least registration details of the user 109. The system 101 may be further configured to transmit the second set of information to the blockchain network 103 associated with the first cryptographic asset 113. The second set of information may be associated with at least details of the first cryptographic asset 113. The system 101 may be further configured to generate an order for the transaction of the first cryptographic asset 113, based on the retrieved first set of information and the transmitted second set of information, to complete the transaction of the first cryptographic asset 113. Details of the first cryptographic asset transaction (such as purchase) of the first cryptographic asset 113 are further provided, for example, in FIG. 4.

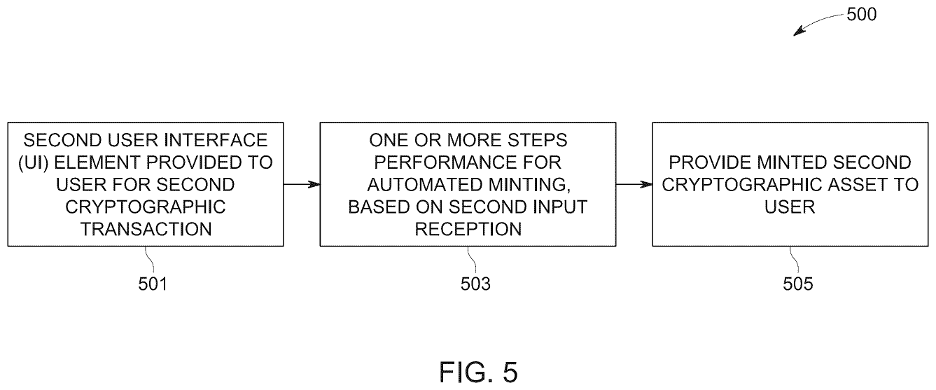

In some embodiments, the system 101 may be further configured to provide a second UI element on the UI 111 to the user 109 for performing at least a second cryptographic asset transaction. The second cryptographic asset transaction may be associated with minting of a second cryptographic asset based on a preference of the user 109. The system 101 may perform one or more steps for automated minting of the one or more second cryptographic assets, based on a second input received corresponding to the second UI element. In an embodiment, the performance of the one or more steps may include utilization of one or more UI scripting languages for the minting of the second cryptographic asset. Details of the minting of the second cryptographic asset are further provided, for example, in FIG. 5.

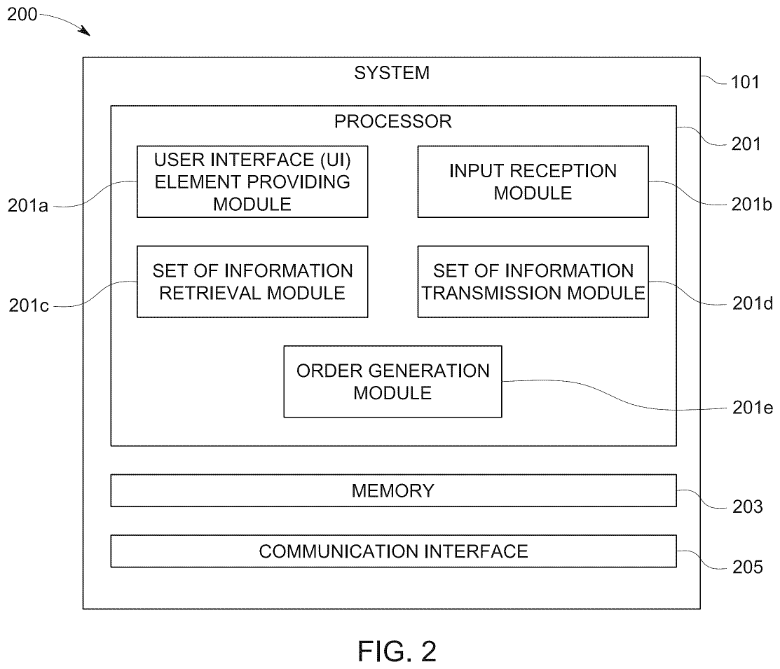

FIG. 2 is a block diagram 200 of the system of FIG. 1 for implementing various embodiments. FIG. 2 is explained in conjunction with elements of FIG. 1. The block diagram 200 may include the system 101. The system 101 may include a processor 201, a memory 203 and a communication interface 205. The processor 201 may further include a UI element providing module 201a, an input reception module 201b, a set of information retrieval module 201c, a set of information transmission module 201d and an order generation module 201e.

The processor 201 may be embodied in a number of different ways. For example, the processor 201 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 201 may include one or more processing cores configured to perform independently. A multi-core processor may enable multiprocessing within a single physical package. Additionally, or alternatively, the processor 201 may include one or more processors configured in tandem via the bus to enable independent execution of instructions, pipelining and/or multithreading.

In some embodiments, the UI element providing module 201a may be configured to provide the first UI element 115 on the UI 111 to the user 109 for performing at least the first cryptographic asset transaction. The input reception module 201b may be configured to receive the first input corresponding to the UI element 115. The set of information retrieval module 201c may be configured to retrieve the first set of information associated with the user 109. The set of information transmission module 201d may be configured to transmit the second set of information to the blockchain network 103 associated with the first cryptographic asset 113. The order generation module 201e may be configured to generate the order for the transaction of the first cryptographic asset 113, based on the retrieved first set of information and the transmitted second set of information, to complete the transaction of the first cryptographic asset.

Additionally, or alternatively, the processor 201 may include one or more processors capable of processing large volumes of workloads and operations for the transaction of the plurality of cryptographic assets 113. In an example embodiment, the processor 201 may be in communication with the memory 203 via a bus for passing information among components coupled to the system 101.

The memory 203 may be non-transitory and may include, for example, one or more volatile and/or non-volatile memories. In other words, for example, the memory 203 may be an electronic storage device (for example, a computer readable storage medium) comprising gates configured to store data (for example, bits) that may be retrievable by a machine (for example, a computing device like the processor 201). The memory 203 may be configured to store information, data, content, applications, instructions, or the like, for enabling the apparatus to carry out various functions in accordance with an example embodiment of the present invention. For example, the memory 203 may be configured to buffer input data for processing by the processor 201. Examples of non-volatile memory may include, but are not limited to a flash memory, a Read Only Memory (ROM), a Programmable ROM (PROM), Erasable PROM (EPROM), and Electrically EPROM (EEPROM) memory. Examples of volatile memory may include but are not limited to Dynamic Random-Access Memory (DRAM), and Static Random-Access memory (SRAM). The memory 203 may also store various data (e.g. the set of information, data associated with the transacted one or more first cryptographic assets, etc.) that may be processed, and/or required by the system 101. As exemplarily illustrated in FIG. 2, the memory 203 may be communicatively coupled to the processor 201 and may be configured to store a plurality of processor-executable instructions for execution by the processor 201. As such, whether configured by hardware or software methods, or by a combination thereof, the processor 201 may represent an entity (for example, physically embodied in circuitry) capable of performing operations according to an embodiment of the present invention while configured accordingly. Thus, for example, when the processor 201 is embodied as an ASIC, FPGA or the like, the processor 201 may be specifically configured hardware for conducting the operations described herein. Alternatively, as another example, when the processor 201 is embodied as an executor of software instructions, the instructions may specifically configure the processor 201 to perform the algorithms and/or operations described herein when the instructions are executed. However, in some cases, the processor 201 may be a processor specific device (for example, a mobile terminal or a fixed computing device) configured to employ an embodiment of the present invention by further configuration of the processor 201 by instructions for performing the algorithms and/or operations described herein. The processor 201 may include, among other things, a clock, an arithmetic logic unit (ALU) and logic gates configured to support operation of the processor 201.

The communication interface 205 may comprise input interface and output interface for supporting communications to and from the system 101 or any other component with which the system 101 may communicate. The communication interface 205 may be any means such as a device or circuitry embodied in either hardware or a combination of hardware and software that is configured to receive and/or transmit data to/from a communications device in communication with the system 101. In this regard, the communication interface 205 may include, for example, an antenna (or multiple antennae) and supporting hardware and/or software for enabling communications with a wireless communication network. Additionally, or alternatively, the communication interface 205 may include the circuitry for interacting with the antenna(s) to cause transmission of signals via the antenna(s) or to handle receipt of signals received via the antenna(s). In some environments, the communication interface 205 may alternatively or additionally support wired communication. As such, for example, the communication interface 205 may include a communication modem and/or other hardware and/or software for supporting communication via cable, digital subscriber line (DSL), universal serial bus (USB) or other mechanisms.

FIG. 3 is a block diagram 300 for a registration process of a user, in accordance with an embodiment. FIG. 3 is explained in conjunction with elements of FIGS. 1 and 2. The block diagram 300 may include steps 301 to 307. It will be understood that each step of the block diagram 300 may be implemented by various means, such as hardware, firmware, processor, circuitry, and/or other communication devices associated with execution of software including one or more computer program instructions.

At step 301, the registration details associated with the user 109 may be received via the UI 111 associated with the plurality of cryptographic assets 113. In some embodiments, the processor 201 may be configured to receive the registration details associated with the user 109. The registration details may include at least data associated with the cryptographic wallet associated with the user 109. The registration details may include details of the user, for example, a name of the user 109, a contact number of the user 109, a registered electronic mail (e-mail) of the user 109 and a date of birth of the user 109. The registered e-mail may be used to verify an identity of the user 109. The date of birth of the user 109 may be used to verify an age of the user 109. In an embodiment, the registration details may further include a photograph of the user 109. The registration details may further include a contract signed by the user 109 associated with terms and conditions of usage of the platform of the plurality of cryptographic assets 113.

The data associated with the cryptographic wallet associated with the user 109 may include information about the blockchain network 103 on which the user 109 may be registered. In an embodiment, the transactions associated with the NFTs may require use of cryptographic elements, such as cryptocurrencies. For the usage of the cryptocurrencies, the user 109 may require purchasing of the cryptocurrencies, and the purchased cryptocurrencies may be reflected in the cryptographic wallet associated with the user 109. For example, the cryptographic wallet may be associated with the Ethereum blockchain. The data associated with the cryptographic wallet may include an amount of cryptocurrency “Ether” associated with the blockchain Ethereum present in the cryptographic wallet of the user 109. Thus, the registration details associated with the user 109 may include the details associated with the user 109 as well as the data associated with the cryptographic wallet associated with the user 109.

At step 303, the user account associated with the user 109 may be generated on the UI 111, based on the received registration details. In some embodiments, the processor 201 may be configured to generate the user account associated with the user 109, based on the received registration details. The cryptographic wallet associated with the user 109 may be linked with the generated user account. The user account may include information, such as the name of the user 109, the registered e-mail of the user 109 and the details of the linked cryptographic wallet associated with the user 109. The registration details of the user 109 may be verified by the processor 201 for the transaction of the plurality of cryptographic assets such as the first cryptographic asset 113.

At step 305, registration of one or more cryptographic elements with the linked cryptographic wallet may be enabled. In some embodiments, the processor 201 may be configured to enable the registration of one or more cryptographic elements with the linked cryptographic wallet. The one or more cryptographic elements may be for example, the cryptocurrencies associated with various blockchains. For example, the one or more cryptographic elements may be “Ether”, “Bitcoin”, “Algo” and the like. The one or more cryptographic elements may be registered to the cryptographic wallet associated with the user 109 for ease of the asset transactions. The registration of one or more cryptographic elements may enable simple hassle-free transactions on the UI 111.

At step 307, the one or more cryptographic elements may be utilized for the transaction of the first cryptographic asset 113. In some embodiments, the processor 201 may be configured to utilize the one or more cryptographic elements for the transaction of the first cryptographic asset 113. For example, the cryptocurrency “Ether” may be utilized to purchase the first cryptographic asset 113. In another example, the cryptocurrency “Algo” may be utilized to purchase the first cryptographic asset 113. Thus, the system 101 may enable utilization of the cryptocurrency associated with multiple blockchain networks in a simplified manner.

FIG. 4 is a block diagram for purchase of a first cryptographic asset based on a single action performed by a user, in accordance with an embodiment. FIG. 4 is explained in conjunction with elements of FIGS. 1, 2 and 3. The block diagram 400 may include steps 401 to 415. It will be understood that each step of the block diagram 400 may be implemented by various means, such as hardware, firmware, processor, circuitry, and/or other communication devices associated with execution of software including one or more computer program instructions.

At step 401, the first UI element 115 may be provided to the user 109 for performing at least the first cryptographic asset transaction of the first cryptographic asset 113. For example, the UI 111 may be rendered on the electronic device 105. The electronic device 105 may be a smartphone associated with the user 109. The first UI element 115 may be for example, a button-shaped icon that may be utilized for the first cryptographic asset transaction.

In some embodiments, the first cryptographic asset transaction may correspond to purchase of the first cryptographic asset 113. The platform associated with the UI 111 may be utilized for the cryptographic asset transactions, such as the purchase of the first cryptographic asset 113. The system 101 may enable purchase of a plurality of cryptographic asset via the platform.

In some embodiments, the first cryptographic asset 113 may be the NFT. The NFT may be, for example, images (such as digital art), videos, audio and in-game characters. The NFTs include a digital signature, and thus are unique entities that may be impossible to duplicate. Thus, the purchaser of the NFTs may acquire exclusive ownership rights. The plurality of cryptographic assets may be displayed on the UI 111 to the user 109. The displayed one or more cryptographic assets of the plurality of cryptographic assets may be purchased by the user 109. For example, the first cryptographic asset 113 may be displayed on the UI 111. The details of the first cryptographic asset 113, such as a cost of the first cryptographic asset 113, and other features of the first cryptographic asset 113 may be displayed along with the first cryptographic asset 113. The first UI element 115 may be provided on the UI 111 beside the first cryptographic asset 113.

At step 403, the first input corresponding to the first UI element 115 may be received, for initiation of at least the first cryptographic asset transaction. The first input may correspond to a single action performed by the user 109. The first UI element 115 may be displayed on the UI 111 rendered on the electronic device 105. The first cryptographic asset 113 may be selected by the user 109 for purchase. For the initiation of the purchase of the first cryptographic asset 113, the first input may be received from the user 109. For example, the first input may be a touch input corresponding to the first UI element 115. In another example, the first input may be a selection of the first UI element 115 by use of an input device, such as a keypad. Thus, for the purchase of the first UI element 115, only the single action needs to be performed by the user 109. The system 101 may enable the purchase of the first cryptographic asset 113, without a need to provide details such as payment details for each cryptographic asset transaction.

At 405, the first set of information associated with the user 109 may be retrieved, based on the received first input. The first set of information may be associated with at least registration details of the user 109. The registration details may include details, such as the name of the user 109, the contact number of the user 109, the registered e-mail of the user 109 and the date of birth of the user 109. The registration details may further include data associated with the cryptographic wallet associated with the user 109, such as the one or more cryptographic elements used by the user 109 for the cryptographic asset transaction. The first set of information may further include information about the electronic device 1105 of the user 109. The first set of information may be utilized to verify an identity of the user 109 registered on the platform.

At 407, a secure file associated with the transacted first cryptographic asset 113 may be generated, based on the received first input. In some embodiments, the processor 201 may be configured to generate the secure file associated with the transacted first cryptographic asset 113, based on the received first input. The generated secure file may be further based on the retrieved first set of information associated with the user 109.

In some embodiments, the generated secure file may include at least one of data associated with the transacted first cryptographic asset 113, authentication data associated with the first cryptographic asset 113, and information of goods associated with the first cryptographic asset 113. For example, the data associated with the transacted first cryptographic asset 113 may include a type of the first cryptographic asset 113, such as the NFT. The data associated with the transacted first cryptographic asset 113 may further include an origin of the first cryptographic asset 113, an owner of the first cryptographic asset 113, the blockchain network associated with the first cryptographic asset 113 and the like. The authentication data associated with the first cryptographic asset 113 may include data required for the secure transaction of the first cryptographic asset 113, such as verification data retrieved from the blockchain network 103. The information of goods may include the details of a digital file of the first cryptographic asset 113.

At 409, the purchase code may be generated based on the generated secure file. The purchase code may be required for the purchase of the first cryptographic asset 113. The purchase code may be a unique code for each transaction associated with the purchase. Such purchase code may be, for example, valid for a predefined period of time. The predefined period of time may range between a few seconds till a few minutes. In an embodiment, the validity of the purchase code may not be for the predefined period of time. The purchase code may include details required for the authentication of the purchase of the first cryptographic asset 113.

At 411, the purchase code may be transferred to a user account associated with the user 109. The user may be registered on the UI 111 associated with a plurality of cryptographic assets. The user account associated with the user 109 may be generated based on the registration details provided by the user 109. The purchase code may be transferred to the user 109 upon reception of the first input for the purchase of the first cryptographic asset 113.

In one or more embodiments, the user 109 may be a first-time user or may not have the user account registered on the platform. In such a case, after generation of the secure file, the system 101 may receive the registration details of the user 109 to proceed with the generation of the purchase code. The purchase code may be transferred after generation of the user account of the user 109 based on the received registration details of the user 109.

At 413, the second set of information may be transmitted to the blockchain network 103 associated with the first cryptographic asset 113. The second set of information may be associated with at least details of the first cryptographic asset 113. The second set of information may include the details, such as a cost of the first cryptographic asset 113, details of an ownership of the first cryptographic asset 113 registered on the blockchain network 103, and details of the blockchain network 103.

The second set of information may be utilized by the blockchain network 103 to update the ownership of the first cryptographic asset 113, based on the purchase of the first cryptographic asset 113. The second set of information may further be utilized by the blockchain network 103 to validate the cryptographic asset transaction, such as the purchase of the first cryptographic asset 113 associated with the blockchain network 103.

At 415, the order for the transaction of the first cryptographic asset 113 may be generated, based on the retrieved first set of information and the transmitted second set of information, to complete the transaction of the first cryptographic asset 113. A notification associated with the generated order may be displayed to the user 109 on the UI 111. In some embodiments, the order for the transaction of the first cryptographic asset 113 may be generated, based on the transferred purchase code, the retrieved first set of information and the transmitted second set of information, to complete the transaction of the first cryptographic asset 113. The transferred purchase code may be used as a validation of the user account associated with the user 109. After the completion of the transaction of the first cryptographic asset 113, the purchased first cryptographic asset 113 may be transferred as a digital asset to the user account of the user 109 registered on the platform.

FIG. 5 is a block diagram for minting of a second cryptographic asset, based on a preference of a user, in accordance with an embodiment. FIG. 5 is explained in conjunction with elements of FIGS. 1, 2, 3 and 4. The block diagram 500 may include steps 501 to 505. It will be understood that each step of the block diagram 500 may be implemented by various means, such as hardware, firmware, processor, circuitry, and/or other communication devices associated with execution of software including one or more computer program instructions.

At step 501, a second UI element may be provided to the user 109 for performing at least a second cryptographic asset transaction. The second cryptographic asset transaction may be associated with minting of a second cryptographic asset based on a preference of the user 109. In an embodiment, the platform may be utilized by the user 109 for minting of one or more cryptographic assets, such as the second cryptographic asset. The second cryptographic asset transaction may be performed on demand of the user 109. In an example, a digital art created by the user 109 may require to be minted as the second cryptographic asset, such as the NFT. For minting of the second cryptographic asset, based on the digital art, the platform may be utilized by the user 109.

At 503, one or more steps for automated minting of the second cryptographic asset may be performed, based on a second input received corresponding to the second UI element. For example, conventionally, the minting of the NFTs may be technically challenging for the user 109. The system 101 may enable automated minting of the second cryptographic asset, such that the minting of the second cryptographic asset may be performed automatically for the user 109.

In some embodiments, the one or more steps for the automated minting may include at least utilization of one or more UI scripting languages for the minting of the second cryptographic asset. The one or more UI scripting languages may enable conversion of an article, such as the digital art into the NFT. The one or more UI scripting languages may be used for the automation of the execution of tasks, that would be required to be performed by the user 109. The one or more UI scripting languages may be interpreted one line at a time, and may not require compilation beforehand. Thus, the one or more UI scripting languages may be suitably utilized by the system 101 for the automated minting of the second cryptographic asset, i.e., conversion of the article, such as the digital art into the NFT.

In some embodiments, the one or more UI scripting languages may include at least one of PHP Hypertext Preprocessor language, JavaScript language, and Python language. The PHP Hypertext Preprocessor language may be an open-source general purpose scripting language that may be embedded into hypertext markup language (HTML). The JavaScript language may be a high-level, just-in-time compiled language. The Python language may be the high-level, interpreted, general-purpose programming language. Such ne or more UI scripting languages may be utilized for the automated minting of the second cryptographic asset.

At 505, the minted second cryptographic asset may be provided to the user 109. The minted second cryptographic asset may be viewed by the user 109 by accessing the user account registered on the platform. The second cryptographic asset may require usage of the one or more cryptographic elements for the minting.

In some embodiments, the processor 201 may further utilize the minted second cryptographic asset for the transaction of the first cryptographic asset 113. For example, the second cryptographic asset may be utilized as a payment method for the purchase of the first cryptographic asset 113.

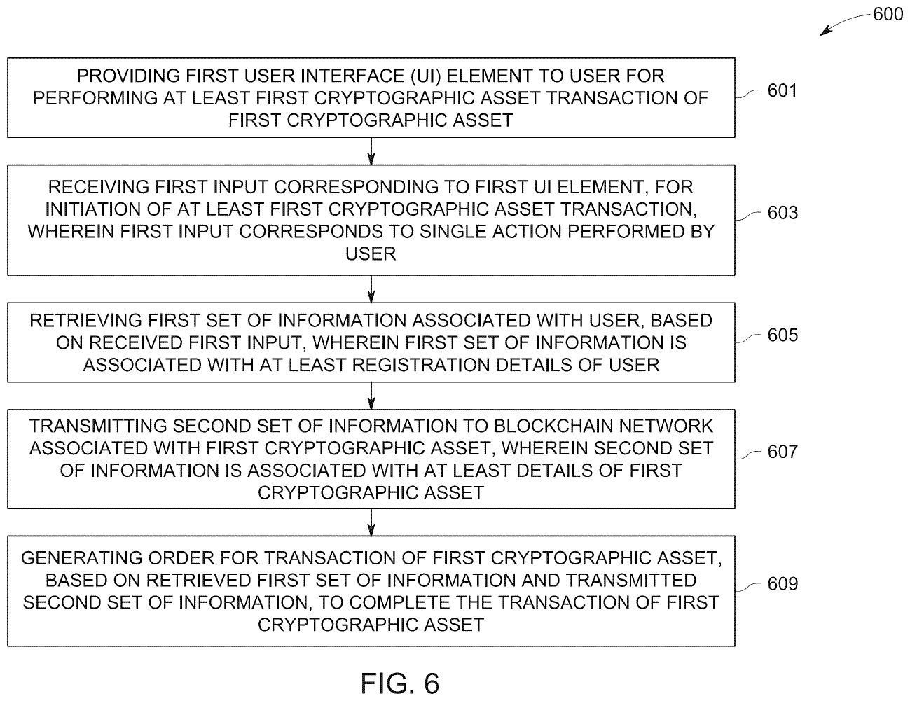

FIG. 6 is a flowchart 600 illustrating a method for cryptographic asset transaction, in accordance with an embodiment. The method may include various steps performed by the system 101 in order to perform the first cryptographic asset transaction associated with the first cryptographic asset 113. It will be understood that each block of the flow diagram of the method 600 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 203 of the system 101, employing an embodiment of the present invention and executed by a processor 201. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

At step 601, the first UI element 115 may be provided on the UI 111 to the user 109 for performing at least the first cryptographic asset transaction. In accordance with an embodiment, the processor 201 may be configured to provide the first UI element 115 on the UI 111 to the user 109 for performing at least the first cryptographic asset transaction. The UI 111 may be associated with the platform for the cryptographic asset transaction. In some embodiments, the first cryptographic asset transaction may correspond to purchase of the first cryptographic asset 113. In an embodiment, the first cryptographic asset 113 may be NFTs. Details of the providing of the first UI element 115 are provided, for example, in FIG. 4.

At step 603, the first input corresponding to the first UI element 115 may be received. In accordance with an embodiment, the processor 201 may be configured to receive the first input corresponding to the first UI element 115, for initiation of at least the first cryptographic asset transaction. The first input may correspond to the single action performed by the user 109. In some embodiments, the first input may be for example, the touch input that replicates a single click input. Details of the reception of the first input are provided, for example, in FIG. 4.

At step 605, the first set of information associated with the user 109 may be retrieved, based on the received first input. In accordance with an embodiment, the processor 201 may be configured to retrieve the first set of information associated with the user 109, based on the received first input. The first set of information may be associated with at least registration details of the user 109. Details of the retrieval of the first set of information are provided, for example, in FIG. 4.

At step 607, the second set of information may be transmitted to the blockchain network 103 associated with the first cryptographic asset 113. In accordance with an embodiment, the processor 201 may be configured to transmit the second set of information to the blockchain network 103 associated with the first cryptographic asset 113. The second set of information may be associated with at least details of the first cryptographic asset 113. Details of the transmission of the second set of information are provided, for example, in FIG. 4.

At step 607, the order for the transaction of the first cryptographic asset 113 may be generated, based on the retrieved first set of information and the transmitted second set of information, to complete the transaction of the first cryptographic asset 113. In accordance with an embodiment, the processor 201 may be configured to generate the order for the transaction of the first cryptographic asset 113, based on the retrieved first set of information and the transmitted second set of information, to complete the transaction of the first cryptographic asset 113. Details of generation of the order are provided, for example, in FIG. 4.

In some embodiments, the first cryptographic asset transaction may correspond to purchase of the first cryptographic asset 113.

In some embodiments, the first cryptographic asset may be NFTs.

In some embodiments, the secure file associated with the transacted first cryptographic asset 113 may be generated, based on the received first input. based on the generated secure file, the purchase code may be generated. The purchase code may be transferred to the user account associated with the user 109 registered on the UI 111 associated with the plurality of cryptographic assets. The order may be generated for the transaction of the first cryptographic asset 113 based on the transferred purchase code to the user account, the retrieved first set of information, and the second set of information transmitted, to complete the transaction of the first cryptographic asset.

In some embodiments, the generated secure file may include at least one of data associated with the transacted first cryptographic asset 113, authentication data associated with the transacted first cryptographic asset 113, and information of goods associated with the first cryptographic asset 113.

In some embodiments, the second UI element may be provided on the UI 111 to the user 109 for performing at least the second cryptographic asset transaction. At least the second cryptographic asset transaction may be associated with minting of the second cryptographic asset based on the preference of the user. The one or more steps may further be performed for automated minting of the second cryptographic asset, based on a second input received corresponding to the second UI element.

In some embodiments, the minted second cryptographic asset may be utilized for the transaction of the first cryptographic asset 113.

In some embodiments, the performed one or more steps for the automated minting may include at least utilization of one or more UI scripting languages for the minting of the second cryptographic asset.

In some embodiments, the one or more UI scripting languages may include at least one of PHP Hypertext Preprocessor language, JavaScript language, and Python language.

In some embodiments, the registration details associated with the user 109 may be received via the UI 111 associated with the plurality of cryptographic assets 113. The registration details may include at least data associated with the cryptographic wallet associated with the user 109. Based on the received registration details, the user account associated with the user 109 may be generated on the UI 111. The cryptographic wallet associated with the user 109 may be linked with the generated user account.

In some embodiments, the registration of the one or more cryptographic elements with the linked cryptographic wallet may be enabled. The one or more cryptographic elements may be utilized for the transaction of the one or more first cryptographic assets of the plurality of cryptographic assets 113.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

The disclosed methods and systems may be implemented on a conventional or a general-purpose computer system, such as a personal computer (PC) or server computer. It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A system for cryptographic asset transaction, the system comprising:
a processor;
a memory communicatively coupled to the processor, wherein the memory stores a plurality of processor-executable instructions which upon execution by the processor cause the processor to:
provide a first user interface (UI) element to a user for performing at least a first cryptographic asset transaction of a first cryptographic asset;
receive a first input corresponding to the first UI element, for initiation of at least the first cryptographic asset transaction, wherein the first input corresponds to a single action performed by the user;
retrieve a first set of information associated with the user, based on the received first input, wherein the first set of information is associated with at least registration details of the user;
transmit a second set of information to a blockchain network associated with the first cryptographic asset, wherein the second set of information is associated with at least details of the first cryptographic asset; and
generate an order for the transaction of the first cryptographic asset, based on the retrieved first set of information and the transmitted second set of information, to complete the transaction of the first cryptographic asset.

2. The system of claim 1, wherein the first cryptographic asset transaction corresponds to purchase of the first cryptographic asset.

3. The system of claim 1, wherein the first cryptographic asset is a non-fungible token (NFT).

4. The system of claim 1, wherein the plurality of processor-executable instructions, upon execution by the processor, further cause the processor to:
generate a secure file associated with the transacted first cryptographic asset, based on the received first input;
generate a purchase code based on the generated secure file;
transfer the purchase code to a user account associated with the user wherein the user is registered on a UI associated with a plurality of cryptographic assets; and
generate the order for the transaction of the first cryptographic asset, based on the transferred purchase code, the retrieved first set of information and the transmitted second set of information, to complete the transaction of the first cryptographic asset.

5. The system of claim 4, wherein the generated secure file comprises at least one of: data associated with the transacted first cryptographic asset, authentication data associated with the first cryptographic asset, and information of goods associated with the first cryptographic asset.

6. The system of claim 1, wherein the plurality of processor-executable instructions, upon execution by the processor, further cause the processor to:
provide a second UI element to the user for performing at least a second cryptographic asset transaction, wherein at least the second cryptographic asset transaction is associated with minting of a second cryptographic asset based on a preference of the user; and
perform one or more steps for automated minting of the second cryptographic asset, based on a second input received corresponding to the second UI element.

7. The system of claim 6, wherein the plurality of processor-executable instructions, upon execution by the processor, further cause the processor to utilize the minted second cryptographic asset for the transaction of the first cryptographic asset.

8. The system of claim 6, wherein the performed one or more steps for the automated minting comprises at least utilization of one or more UI scripting languages for the minting of the second cryptographic asset.

9. The system of claim 8, wherein the one or more UI scripting languages comprises at least one of: PHP Hypertext Preprocessor language, JavaScript language, and Python language.

10. The system of claim 1, wherein the plurality of processor-executable instructions, upon execution by the processor, further cause the processor to:
receive registration details associated with the user via a UI associated with a plurality of cryptographic assets, wherein the registration details include at least data associated with a cryptographic wallet associated with the user; and
generate a user account associated with the user on the UI, based on the received registration details, wherein the cryptographic wallet associated with the user is linked with the generated user account.

11. The system of claim 10, wherein the plurality of processor-executable instructions, upon execution by the processor, further cause the processor to:
enable registration of one or more cryptographic elements with the linked cryptographic wallet; and
utilize the one or more cryptographic elements for the transaction of the first cryptographic asset.

12. A method of cryptographic asset transaction comprising:
providing a first user interface (UI) element to a user for performing at least a first cryptographic asset transaction of a first cryptographic asset;
receiving a first input corresponding to the first UI element, for initiation of at least the first cryptographic asset transaction, wherein the first input corresponds to a single action performed by the user;
retrieving a first set of information associated with the user, based on the received first input, wherein the first set of information is associated with at least registration details of the user;
transmitting a second set of information to a blockchain network associated with the first cryptographic asset, wherein the second set of information is associated with at least details of the first cryptographic asset; and
generating an order for the transaction of the first cryptographic asset, based on the retrieved first set of information and the transmitted second set of information, to complete the transaction of the first cryptographic asset.

13. The method of claim 12, wherein the first cryptographic asset transaction corresponds to purchase of the first cryptographic asset.

14. The method of claim 12, wherein the first cryptographic asset is a non-fungible token (NFT).

15. The method of claim 12, further comprising:
generating a secure file associated with the transacted first cryptographic asset, based on the received first input;
generating a purchase code based on the generated secure file;
transferring the purchase code to a user account associated with the user wherein the user is registered on a UI associated with a plurality of cryptographic assets; and
generating the order for the transaction of the first cryptographic asset, based on the transferred purchase code, the retrieved first set of information and the transmitted second set of information, to complete the transaction of the first cryptographic asset.

16. The method of claim 15, wherein the generated secure file comprises at least one of: data associated with the transacted first cryptographic asset, authentication data associated with the first cryptographic asset, and information of goods associated with the first cryptographic asset.

17. The method of claim 12, further comprising:
providing a second UI element to the user for performing at least a second cryptographic asset transaction, wherein at least the second cryptographic asset transaction is associated with minting of a second cryptographic asset based on a preference of the user; and
performing one or more steps for automated minting of the second cryptographic asset, based on a second input received corresponding to the second UI element.

18. The method of claim 17, further comprising utilizing the minted second cryptographic asset for the transaction of the first cryptographic asset.

19. The method of claim 17, wherein the performed one or more steps for the automated minting comprises at least utilizing of one or more UI scripting languages for the minting of the second cryptographic asset.

20. The non-transitory computer-readable medium of claim 19, wherein the computer-executable instructions are further configured for:
providing a first user interface (UI) element to a user for performing at least a first cryptographic asset transaction of a first cryptographic asset;
receiving a first input corresponding to the first UI element, for initiation of at least the first cryptographic asset transaction, wherein the first input corresponds to a single action performed by the user;
retrieving a first set of information associated with the user, based on the received first input, wherein the first set of information is associated with at least registration details of the user;
transmitting a second set of information to a blockchain network associated with the first cryptographic asset, wherein the second set of information is associated with at least details of the first cryptographic asset; and
generating an order for the transaction of the first cryptographic asset, based on the retrieved first set of information and the transmitted second set of information, to complete the transaction of the first cryptographic asset.
